(19) United States
(12) Patent Application Publication
(10) Pub. No.: US 2002/0149460 A1
(43) Pub. Date: Oct. 17, 2002

(54) Pin set of transformer coil and method for manufacturing the same

(76) Inventor: Wen Hao Hsu, Lu Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/834,611

(22) Filed: Apr. 16, 2001

(51) Int. Cl. H01F 27/29

(52) U.S. Cl. 336/192

(57) ABSTRACT

The method for manufacturing a pin set of a transformer comprises the steps of making material of a transformer coil; cutting a material strip of the material; and mold-punching pins of the transformer coil so that a distal end of the pin is formed with an enclosing surface and the pins are punched to have a complete metal enclosing layer. In the present invention, by molding punching, the distal end of each pin is formed with a cambered surface, and the whole surface of the pin is plated with tin or lead completely. That is, it has a preferred horizonalness so as to reduce the ratio of undesirable goods.

### FIELD OF THE INVENTION

The present invention relates to the pin set of a transformer coil and the manufacturing of the same, and especially to a manufacturing method by punching through a special mold, the pines of the transformer coil have complete surface plated with tin.

### BACKGROUND OF THE INVENTION

In the manufacturing process, at first, a transformer coil material 1a (referring to FIG. 1) is made. In the transformer coil material 1a, a material strip 10a is used to connect a plurality of individual transformer coil. Namely, a metal piece is punched continuously to be formed with a plurality of pins 11a spaced arranged. Then pins 11a are plated with tin material 13a. Then, the coil body 12a is combined to a respective pins 11a by injection molding so as to be formed as a material of a transformer coil (referring to FIG. 2). Moreover, by a mold (not shown) capable of being cut and punching directly. That is, the material strip 10a is cut and the pins 11a are bent simultaneously so as to be formed with single transformer coil (referring to FIG. 3) Furthermore, winding (not shown) winds the coil body 12a. The end portion of the winding (not shown) winds around the supporting frame of the pins 11a and then is welded and fixed. Furthermore, the pins 11a are cut and punched at the same time, the manufacturing process being rapid.

However, this prior art cutting and punching process remains to have the following defects:

(1) After plating the pins 11a, the material strip 10a is cut. Thus, a cut surface is formed at the pin 11a (referring to FIG. 3A). The cut surface is not plated with tin and thus the pins 11a will be oxidized so that it can not be plated to a circuit with tin.

(2) The horizontalness of the bending pins 11a is not preferred so that ratio of the undesirable goods are high (even as high as 40%) and the pins 11a are welded to a PC board by surface mounting technology (SMT). This will induce difficulty in welding.

### SUMMARY OF THE INVENTION

Accordingly, the primary object of the present invention is to provide a pin set of a transformer coil and the method for manufacturing the same, wherein a mold is punched, the pins have complete tin and lead plated surfaces. By punching through the mold, and bending the pins so as to have a preferred horizontalness so that the ratio of undesirable goods is reduced.

To achieve abovesaid object, the present invention provides a pin set of a transformer coil and the method for manufacturing the same. At first, the metal piece is punched with a plurality of pins connected to material strip. Then the pins are enclosed with a metal layer. Then the coil body is combined to the pins by injection so as to be formed with transformer coil material. Moreover, the material strip is cut to be formed with individual transformer coils. Further, in the present invention, a mold is used in punching so that the distal ends of the pins are enclosed with respective enclosing surface. Furthermore, the whole surfaces of the pins have complete metal plating layer.

The various objects and advantages of the present invention will be more readily understood from the following detailed description when read in conjunction with the appended drawing.

### BRIEF DESCRIPTION OF THE DRAWINGS

FIG. 1 is a perspective view of a prior art transformer coil material.

FIG. 2 is a lateral view of the prior art transformer coil material.

FIG. 3 is a perspective view for the product of a prior art transformer coil.

FIG. 3A is an enlarge view of the part A in FIG. 3A.

FIG. 4 is a perspective view showing that in the present invention, material is cut.

FIG. 5 is a lateral view showing the punching condition of the present invention.

FIG. 5A is enlarged view of the part B in FIG. 5A.

FIG. 6 is a perspective view showing the product of the transformer coil in the present invention.

FIG. 6A is a partial enlarged view of part C of FIG. 6.

FIG. 7 shows a flow diagram for the manufacturing method of the pin set of the transformer coil in the present invention.

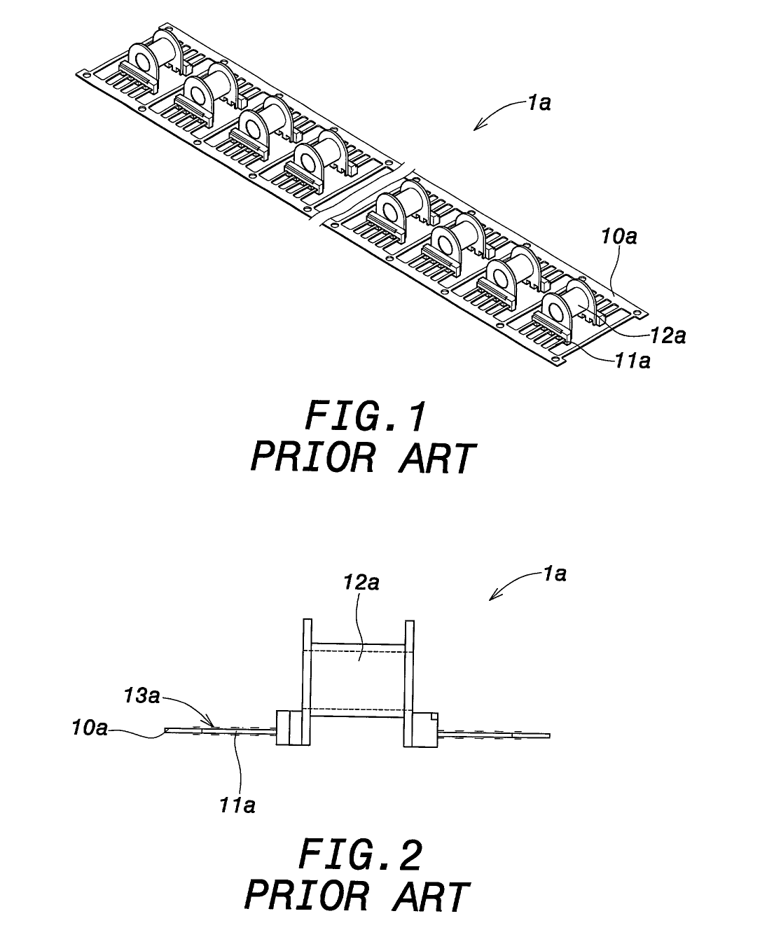

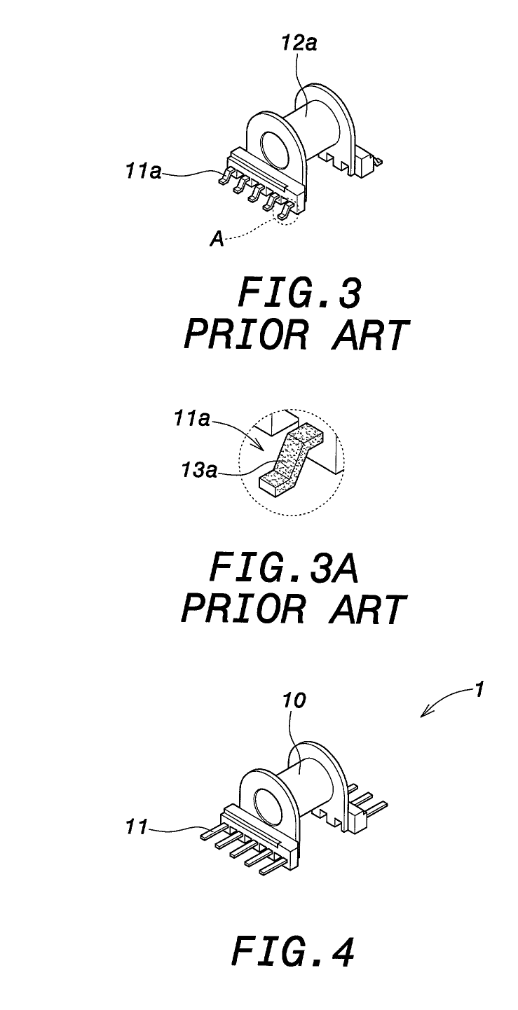

### DETAILED DESCRIPTION OF THE PREFERRED EMBODIMENTS

The structure of the pins of a transformer coil and the manufacturing of the same of the present invention will be described in the following. In the present invention, the transformer coil 1 (referring to FIG. 4) includes a coil body 10 and a plurality of pins 11. The pins 11 are combined to the two sides of the coil body 10 and can be used to fix to a PC board (not shown). Moreover, method for manufacturing the structure of the pins of a transformer coil according to the present invention will be described in the following:

(1) Manufacturing the transformer coil material (not shown): At first, a metal piece is punched to be formed with a plurality of pins 11 connected the material strip. Then the pins 11 are plated with metal. Then the coil body 10 is combined to the pins 11 by injection (Furthermore, it can be made by injection in advance and then being plated with lead or tin).

(2) The material strip is cut (not shown): The abovesaid material strip is cut so as to be formed as individual transformer coils and the pins have cut surface without being plated with lead and tin.

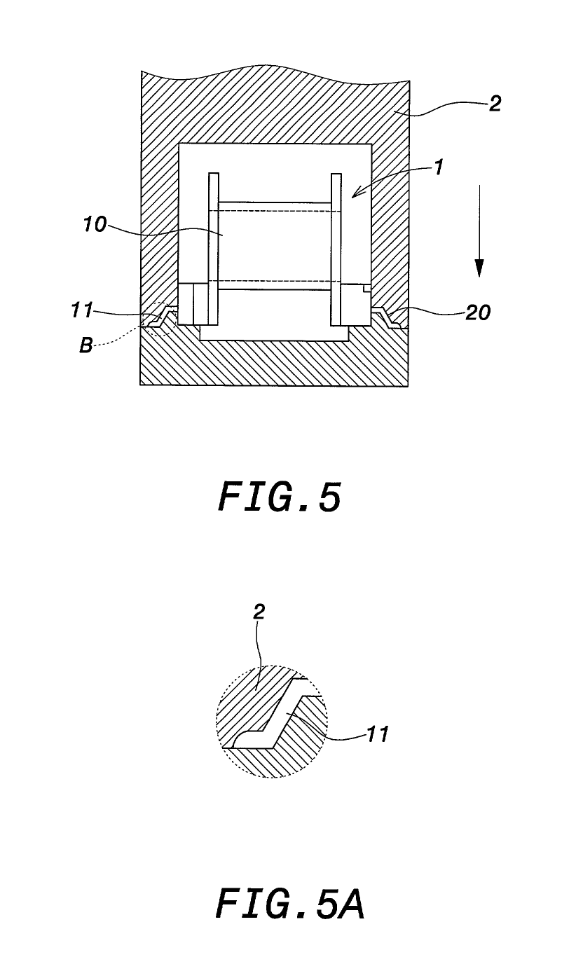

(3) The pins of the transformer coil is punched (referring to FIG. 5) by punching (referring to FIG. 5): A mold 2 is used to punch and the mold 2 includes a male mold and a female mold. The female mold has a plurality of mold cavities 20 with respective to the pins 11. The mold cavity 20 has a folding shape and the distal end thereof has an inner cambered surface (referring to FIG. 5A). Thereby, the distal ends of the pins 11 are formed with respective cambered enclosing surface. Moreover, the lead at the upper edge of the pin 11 covers the cut surface without being plated with lead or tin.

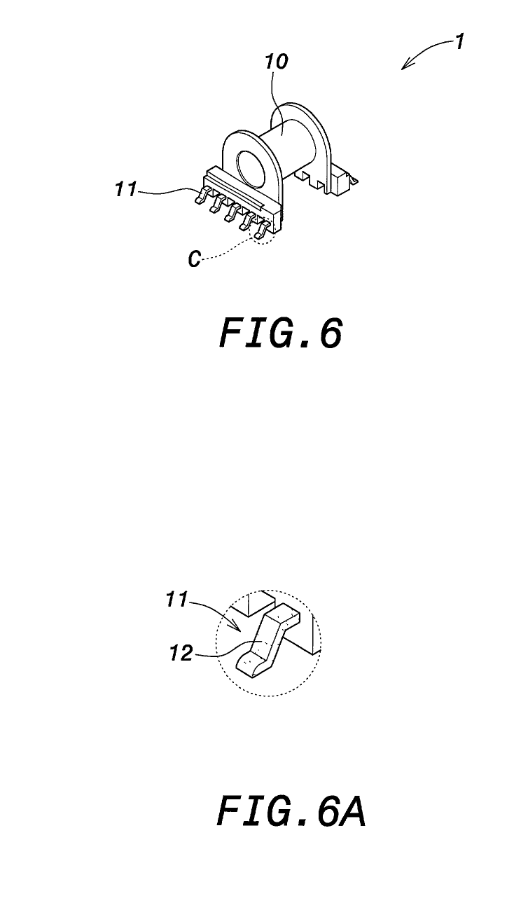

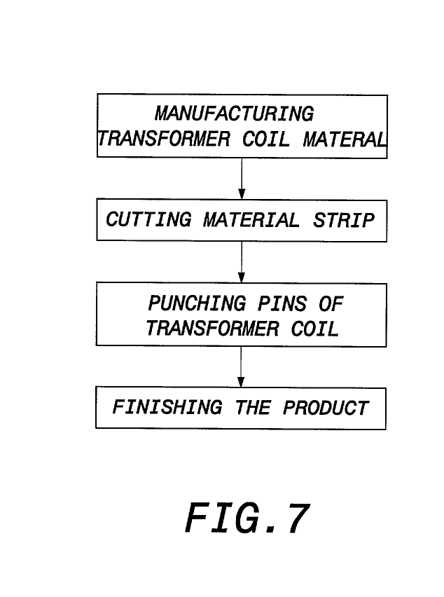

(4) Finishing a product (referring to FIG. 6): By abovesaid manufacturing process, the pins 11 are formed with respective tin and lead plated surfaces 12 (referring to FIG. 6A).

With reference to FIG. 6A, the perspective view of the structure of the pins of a transformer coil and the manufacturing of the same according to the present invention is illustrated. The pins 11 are bent and distal ends thereof are installed with an enclosing surface. The enclosing surface has a semi-cambered shape, and the surface of the pin has complete lead or tin.

The structure of the pins of a transformer coil of the present invention has the following advantages.

(1) After the mold 2 is punched, the pins 11 have complete tin and lead plated surfaces 12.

(2) By punching through the mold 2, and bending the pins, the pins have a preferred horizontalness so that the ratio of undesirable goods is reduced.

(3) By the punched pins, as the pins are welded to a PC board by surface mounting technology. The welding work is easy and the adhesion is better.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A pin set of a transformer coil having a plurality of pins connected to a transformer coil body; each pin being bent, and a distal end of the pin being installed with an enclosing surface, and a surface of each pin having a complete metal enclosing surface.

2. The pin set of a transformer coil as claim in claim 1, wherein the enclosing surface of the pin has a cambered shape.

3. The pin set of a transformer coil as claim in claim 1, wherein the metal enclosing surface is made of gold, tin or metal.

4. The method for manufacturing a pin set of a transformer comprising the steps of:
(1) making material of transformer coil;
(2) cutting a material strip of the material in step (1); and
(3) mold-punching pins of the transformer coil in step (2) so that a distal end of the pin is formed with an enclosing surface and the pins being punched to have a complete metal enclosing layer.

5. The method for manufacturing a pin set of a transformer as claim in claim 4, wherein the enclosing surface in step (3) has a cambered surface.
